(19) United States
(12) Patent Application Publication
(10) Pub. No.: US 2023/0410572 A1
(43) Pub. Date: Dec. 21, 2023

(54) VEHICLE FAULT DIAGNOSIS METHOD, DEVICE, AND COMPUTER-READABLE STORAGE MEDIUM

(71) Applicant: XPT EDS (Hefei) Co., Ltd., Hefei City (CN)

(72) Inventors: Xin GONG, Shanghai (CN); Kai WANG, Shanghai (CN)

(21) Appl. No.: 18/320,269

(22) Filed: May 19, 2023

(30) Foreign Application Priority Data
May 19, 2022 (CN) 202210543427.0

(51) Int. Cl. G07C 5/08

(52) U.S. Cl. CPC G07C 5/0808

(57) ABSTRACT

The disclosure provides a vehicle fault diagnosis method and device, and a computer-readable storage medium. The vehicle fault diagnosis method includes: receiving a grayscale image, where the grayscale image represents diagnostic data for vehicle diagnosis; extracting features from the grayscale image by using a convolutional neural network, to generate a feature map; performing self-attention-based processing on the feature map to obtain a classification result, where the classification result indicates a vehicle fault condition; and performing a relevance propagation analysis based on the classification result to obtain a contribution heat map, where the contribution heat map indicates a degree of contribution of each pixel in the grayscale image to the classification result.

### CROSS-REFERENCE TO RELATED APPLICATIONS

This application claims the benefit of China Patent Application No. 202210543427.0 filed May 19, 2022, the entire contents of which are incorporated herein by reference in its entirety.

### TECHNICAL FIELD

The disclosure relates to the field of vehicle fault diagnosis, and specifically to a vehicle fault diagnosis method and device, and a computer-readable storage medium.

### BACKGROUND

In big data analysis of new energy vehicles, conventional methods for multivariate (that is, multiple sources) time series data analysis are limited by their dependence on expert experience, and thus may be unable to find information outside the realm of experience. In addition, classification results of conventional methods cannot be well explained, which results in a relatively low iterative update speed of machine learning, and further makes it not robust enough after data sample distribution shifts.

In view of this, there is a need for an improved mechanism that can improve vehicle fault diagnosis.

### BRIEF SUMMARY

Embodiments of the disclosure provide a vehicle fault diagnosis method and device, and a computer-readable storage medium, to improve the efficiency and accuracy of vehicle fault diagnosis.

According to an aspect of the disclosure, there is provided a vehicle fault diagnosis method, including the following steps: receiving a grayscale image, where the grayscale image represents diagnostic data for vehicle diagnosis; extracting features from the grayscale image by using a convolutional neural network, to generate a feature map; performing self-attention-based processing on the feature map to obtain a classification result, where the classification result indicates a vehicle fault condition; and performing a relevance propagation analysis based on the classification result to obtain a contribution heat map, where the contribution heat map indicates a degree of contribution of each pixel in the grayscale image to the classification result.

In some embodiments of the disclosure, optionally, the self-attention-based processing includes the following steps: inputting the feature map into a multi-head attention layer of a self-attention neural network to extract a feature matrix; inputting the feature matrix into a dense layer of the self-attention neural network to generate a sparse matrix; and inputting the sparse matrix into a fully connected and softmax layer of the self-attention neural network to obtain the classification result.

In some embodiments of the disclosure, optionally, the grayscale image is generated by the following steps: extracting the diagnostic data, where the diagnostic data includes data generated by at least one source in a vehicle at a plurality of time points; selecting valid data within a predetermined time period from the diagnostic data by filtering; normalizing each value in the valid data; mapping each normalized value in the valid data to a gray level of the grayscale image; and constructing the grayscale image based on the corresponding gray level of each normalized value in the valid data, where the grayscale image has a first dimension corresponding to the source and a second dimension corresponding to the time point.

In some embodiments of the disclosure, optionally, generating the grayscale image further includes the following steps: supplementing a normalized value for each source during a power-off time period after the normalization; and performing filtering on each normalized value in the valid data.

In some embodiments of the disclosure, optionally, the method further includes the following steps: receiving a sample grayscale image and a sample classification result corresponding thereto, where the sample grayscale image represents sample data for vehicle diagnosis, and the sample classification result indicates a vehicle fault condition; and training the convolutional neural network and the self-attention neural network by using the sample grayscale image as an input of the convolutional neural network and the sample classification result as a target output of the self-attention neural network.

In some embodiments of the disclosure, optionally, the sample data is data within a predetermined time period that ends at a time point at which occurrence of a fault is determined according to empirical rules, and the sample classification result is a vehicle fault condition determined according to the empirical rules.

In some embodiments of the disclosure, optionally, the performing a relevance propagation analysis based on the classification result to obtain a contribution heat map includes: performing the relevance propagation analysis based on the classification result by using a relevance analysis neural network, where the relevance analysis neural network includes corresponding layers respectively coupled with all layers in the convolutional neural network and with all the layers in the self-attention neural network.

In some embodiments of the disclosure, optionally, the diagnostic data is generated based on sensor data of a vehicle.

According to another aspect of the disclosure, there is provided a computer-readable storage medium having instructions stored therein, where the instructions, when executed by a processor, cause the processor to perform any one of the vehicle fault diagnosis methods as described above.

According to another aspect of the disclosure, there is provided a vehicle diagnosis device, including: a memory configured to store instructions; and a processor configured to execute the instructions to cause any one of the vehicle fault diagnosis methods as described above to be performed.

### BRIEF DESCRIPTION OF THE SEVERAL VIEWS OF THE DRAWINGS

The above and other objectives and advantages of the disclosure will be more thorough and clearer from the following detailed description in conjunction with the drawings, where the same or similar elements are represented by the same reference numerals.

FIG. 1 shows a vehicle fault diagnosis method according to an embodiment of the disclosure;

FIG. 2 shows a vehicle diagnosis device according to an embodiment of the disclosure;

FIG. 3 shows a grayscale image according to an embodiment of the disclosure; and

FIG. 4 shows a neural network architecture of according to an embodiment of the disclosure.

### DETAILED DESCRIPTION

For the sake of brevity and illustrative purposes, the principles of the disclosure are mainly described herein with reference to its exemplary embodiments. However, those skilled in the art can easily appreciate that the same principle can be equivalently applied to all types of vehicle fault diagnosis methods and devices, and computer-readable storage media, and a same or similar principle can be implemented therein. These variations do not depart from the true spirit and scope of the disclosure.

In the context of the disclosure, unless otherwise specified, vehicle fault diagnosis may refer to a diagnosis on a vehicle in which a fault has occurred, or may refer to a predictive diagnosis on a vehicle in which no fault occurs.

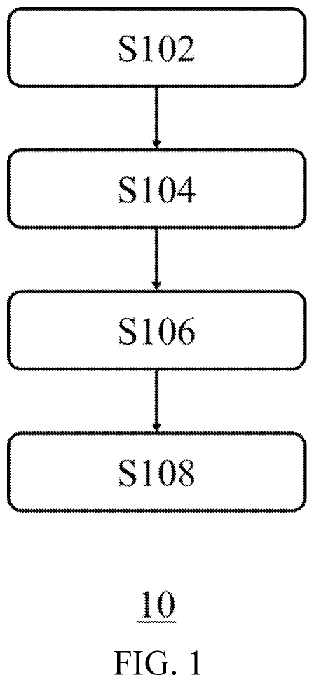

An aspect of the disclosure provides a vehicle fault diagnosis method. As shown in FIG. 1, the vehicle fault diagnosis method 10 includes the following steps: step S102: receiving a grayscale image; step S104: extracting features from the grayscale image by using a convolutional neural network, to generate a feature map; step S106: performing self-attention-based processing on the feature map to obtain a classification result; and step S108: performing a relevance propagation analysis based on the classification result to obtain a contribution heat map. The execution sequence shown by the arrows in FIG. 1 is mainly intended to describe an information flow of products of the various steps. Although the sequence in which the various steps are performed is shown in FIG. 1, this is illustrative only, and these steps may be performed approximately simultaneously in some embodiments. In some other embodiments, these steps may be performed in an interleaved manner.

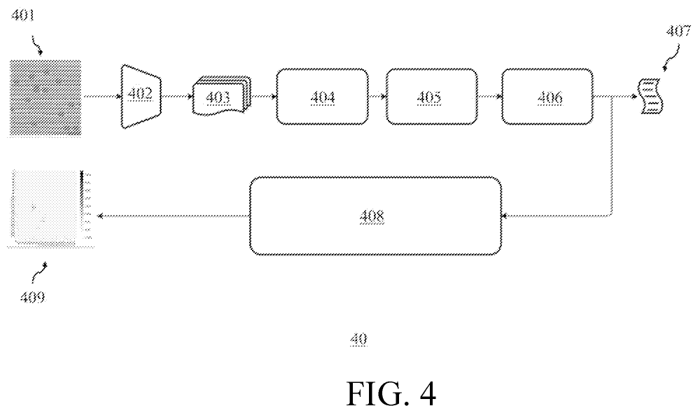

In addition, FIG. 4 shows a neural network architecture 40 according to an embodiment of the disclosure, which may be used to perform the vehicle fault diagnosis method 10 shown in FIG. 1. Some embodiments below will be described with reference to FIG. 1 and FIG. 4, so as to describe the principles of the disclosure in as much detail as possible. It should be noted that the vehicle fault diagnosis method 10 does not necessarily rely on the neural network architecture 40, and in some cases, other forms of neural network architectures may be used to perform the vehicle fault diagnosis method 10 shown in FIG. 1.

In the vehicle fault diagnosis method 10, a grayscale image is received in step S102. The grayscale image described in the disclosure may represent diagnostic data used for vehicle diagnosis, and the diagnostic data may be expressed as numerical values that represent physical quantities in a specific environment. In other words, the grayscale image is a visual representation of the diagnostic data and may also be used as an input of a convolutional neural network 402, for example, in the neural network architecture 40 shown in FIG. 4. In this case, the convolutional neural network 402 will perform vision-based neural network processing.

Since an actual fault in the vehicle is correlated with various physical quantities in a specific environment, there is an objective correlation between the diagnostic data and the vehicle fault, and therefore the diagnostic data can be used to analyze the condition of the vehicle fault. For example, the diagnostic data may include a deflection angle of a steering gear, and the data may be used to analyze a steering fault. Since there is a correlation between the diagnostic data and the vehicle fault, there is also a correlation between the vehicle fault and the grayscale image generated based on the diagnostic data. The analysis on the grayscale image provides a possibility of determining vehicle faults based on data.

In some embodiments of the disclosure, the diagnostic data is generated based on sensor data of a vehicle. With continued reference to the above example, the deflection angle of the steering gear may be collected by, for example, an angular deflection sensor. In some other examples, the diagnostic data may alternatively be collected by, for example, a position sensor, an acceleration sensor, a temperature sensor, etc. Certainly, the diagnostic data may alternatively be obtained from other sources. For example, a motor torque may be generated according to a torque instruction, and thus the torque instruction may also be used to generate diagnostic data for representing the motor torque.

It is worth mentioning that the sensor data of the vehicle may include many types of sensor data, but not every type of sensor data needs to be considered as diagnostic data. Those skilled in the art may select necessary sensor data as a basis for diagnostic data according to experience, causality, etc. after reading the disclosure. For example, it may not be necessary to consider opening or closing of a sunroof when determining whether there is a steering fault, and therefore data of a sunroof sensor may not be included in diagnostic data used for determining whether there is a steering fault.

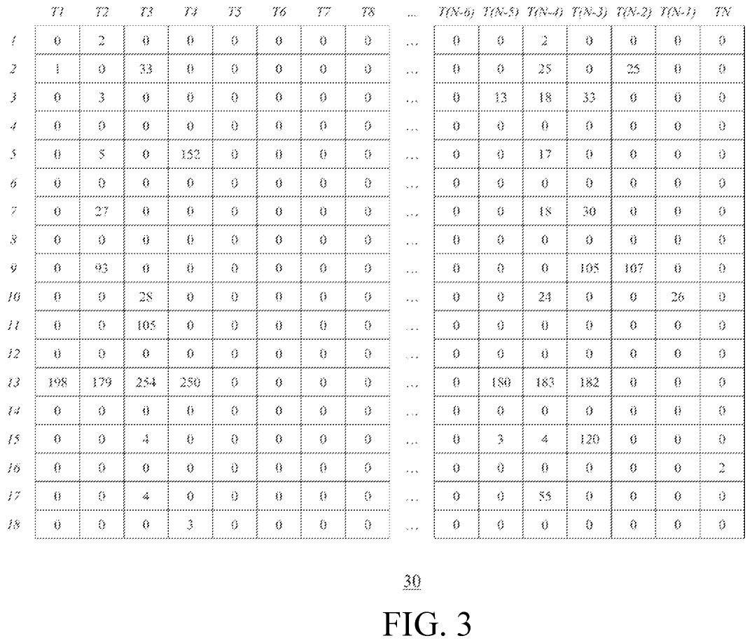

As recited above, the grayscale image may represent diagnostic data. For example, FIG. 3 shows an example of a grayscale image, where each square represents one pixel, and a number inside each square represents a grayscale value of a current pixel (for example, in the case of eight-bit grayscale, the grayscale value ranges from 0 to 255). The grayscale image 30 shown in this figure has 18 rows and N columns, where the 18 rows correspond to 18 sources of diagnostic data, and the N columns represent N time points when the diagnostic data is collected.

In some other examples, the grayscale image 30 shown in FIG. 3 may be further processed. For example, the N columns of the grayscale image 30 are divided into a plurality of groups, and the divided groups are presented as new rows on the grayscale image. As an example, if N is set to be a multiple of 3, the N columns may be divided into three groups, and each group includes (N/3) columns. The divided groups are arranged in the row direction, and therefore the grayscale image after the rearrangement includes (18×3) rows. This division method facilitates a visual presentation of diagnostic data.

In some embodiments of the disclosure, the grayscale image received in step S102 may be generated by the following steps. First, diagnostic data may be extracted from, for example, an on-board diagnostics (OBD) interface of a vehicle. As described above in connection with the example in FIG. 3, the diagnostic data may include data generated by at least one source in the vehicle at a plurality of time points. Specifically, corresponding diagnostic data for the grayscale image 30 shown in FIG. 3 includes data generated by 18 sources in the vehicle at N time points.

Second, valid data within a predetermined time period may be selected from the diagnostic data by filtering. With continued reference to the example in FIG. 3, if diagnostic data is extracted at a moment TN, data within a time period from the moment Ti to the moment TN may be selected as the valid data and data within a time period before the moment Ti may be discarded. This is because earlier data is less correlated with a fault that may occur at the moment TN. In addition, diagnostic data collected after a fault occurs generally exists as a result of the fault, and thus may not be used to analyze causes of the fault in some examples.

Next, each value in the valid data may be normalized. Generally, the data from the various sources have a specific range of values. In order to visualize the data conveniently, the values of these valid data may be mapped to an interval of such as [0, 1]. A mapping method may be, for example, linear mapping, exponential mapping, logarithmic mapping, trigonometric mapping, etc. Normalizing the data from different sources also provides a possibility to map the data to grayscale values of pixels subsequently, so that data from each source may be expressed as grayscale values ranging from 0 to 255.

Then, each normalized value in the valid data may be mapped to a gray level of the grayscale image. For example, values in an interval of [0, 1] may be uniformly mapped to the gray levels ranging from 0 to 255 (eight-bit grayscale). In some other embodiments, the mapping from the normalized values to the grayscale values may alternatively be non-uniform mapping.

Finally, the grayscale image may be constructed based on the corresponding gray level of each normalized value in the valid data. In this way, the grayscale image has a first dimension corresponding to the source (18 rows shown in FIG. 3) and a second dimension corresponding to the time point (N columns shown in FIG. 3).

In some embodiments of the disclosure, the process of generating the grayscale image further includes the following steps. A normalized value for each source during a power-off time period is supplemented after the normalization. Filtering is performed on each normalized value in the valid data, for example, apparently inappropriate values may be filtered out. In this way, supplement to and filtering of the diagnostic data may be implemented, such that the generated grayscale image can reflect changes in the physical environment more accurately, rather than being limited to data fed back by sensors that may include some defects.

With continued reference to the example in FIG. 3, for example, a time period from the time point T5 to the time point T8 in the grayscale image 30 is a power-off time period of the vehicle. In this case, the interval from the time point T5 to the time point T8 may be filled with normalized values belonging to the interval of [0, 1], so as to ensure the continuity of the data. FIG. 3 shows that normalized values of 0s are supplemented for the sources 1 to 18, making the data continuous. In addition, the consecutive 0s may also indicate a power-off parking state of the vehicle. In some other examples, a filling method may alternatively be filling with a typical value (for example, filling with a value with the highest occurrence frequency to make the data continuous and to indicate the power-off parking state of the vehicle), linear interpolation filling, etc.

With continued reference to FIG. 1, in step S104 of the vehicle fault diagnosis method 10, features are extracted from the grayscale image by using a convolutional neural network, to generate a feature map. As shown in FIG. 4, the convolutional neural network 402 in the neural network architecture 40 uses a grayscale image 401 as an input and processes it to generate a feature map 403. The convolutional neural network 402 is adapted to process image information (for example, the grayscale image 401), and it may have a variety of existing structures, and may alternatively have a specially customized structure. The basic principles of the convolutional neural network 402 are already known to most skilled in the art, and may not be repeated herein in the disclosure.

With continued reference to FIG. 1, in step S106 of the vehicle fault diagnosis method 10, self-attention-based processing is performed on the feature map to obtain a classification result, where the classification result indicates a vehicle fault condition. Specifically, in step S106, a plurality of layers such as the layers 404, 405, and 406 in the neural network architecture 40 shown in FIG. 4 may be used to implement self-attention-based classification, to obtain a classification result 407. The number of classification results 407 may vary depending on the type of fault diagnosis that needs to be implemented.

In some embodiments of the disclosure, in step S106, the self-attention-based processing may be completed by using a self-attention neural network including a multi-head attention layer 404, a dense layer 405, and a fully connected and softmax layer 406, and the processing process may include the following steps.

First, the feature map is inputted into the multi-head attention layer 404 of the self-attention neural network to extract a feature matrix, where the feature matrix is used as an output of the multi-head attention layer 404. The multi-head attention layer 404 may not change the scale of the feature map, that is, the generated feature matrix may have the same dimension as the feature map.

Then, the feature matrix is inputted into the dense layer 405 of the self-attention neural network to generate a sparse matrix, where the sparse matrix is used as an output of the dense layer 405. The dense layer 405 makes the original feature matrix sparse and abstract, thereby reducing the dimension of the feature matrix.

Finally, the sparse matrix is inputted into the fully connected and softmax layer 406 of the self-attention neural network to obtain the classification result 407. For example, to implement binary classification of a specific fault, the classification result 407 may be a probability value. If the probability value is greater than or equal to 0.5, it may be determined that the specific fault has occurred (the vehicle fault diagnosis method 10 is used for attribution), or that the specific fault is about to occur (the vehicle fault diagnosis method 10 is used for prediction).

It should be noted that the implementation of the self-attention-based processing by using the architecture composed of the multi-head attention layer 404, the dense layer 405, and the fully connected and softmax layer 406 is only an example, and another architecture may alternatively be used in other embodiments to achieve this purpose.

With continued reference to FIG. 1, in step S108 of the vehicle fault diagnosis method 10, a relevance propagation analysis is performed based on the classification result to obtain a contribution heat map. The method of presenting data in a heat map has been widely used in map hotspot presentation, relevance presentation, etc., and its basic principles have already been well-known to those skilled in the art. As shown in FIG. 4, the contribution heat map 409 may indicate a degree of contribution of each pixel in the grayscale image to the classification result. The contribution analysis is helpful to find the cause of the vehicle fault. For example, if a classification result for a specific fault shows that there is such a fault, and it indicates, based on the contribution heat map 409, that a degree of contribution of the source 17 at the time point T7 is relatively large, it may be inferred that a corresponding operation for hardware corresponding to the source 17 caused this fault at the time point T7. Therefore, those skilled may further analyze, based on the inferred result, whether the attribution of the degree of contribution given in the vehicle fault diagnosis method 10 is appropriate.

In some embodiments of the disclosure, the relevance propagation analysis performed based on the classification result in step S108 may be performed by using a relevance analysis neural network 408 shown in FIG. 4. For example, the relevance analysis neural network 408 may include corresponding layers respectively coupled with all layers (not shown) in the convolutional neural network 402 and with all the layers (the multi-head attention layer 404, the dense layer 405, and the fully connected and softmax layer 406) in the self-attention neural network.

In some examples, each of the corresponding layers in the relevance analysis neural network 408 may have the same structure as the corresponding layer (not shown) in the convolutional neural network 402 and the corresponding layer (the multi-head attention layer 404, the dense layer 405, or the fully connected and softmax layer 406) in the self-attention neural network, and an additional return method is added to transfer intermediate variables in these layers to the corresponding layers in the relevance analysis neural network 408.

In some embodiments of the disclosure, the vehicle fault diagnosis method may further include a process (not shown in FIG. 1) of training, for example, the convolutional neural network 402 and the self-attention neural network (including the multi-head attention layer 404, the dense layer 405, and the fully connected and softmax layer 406) that are shown in FIG. 4. The training process includes: receiving a sample grayscale image and a sample classification result corresponding thereto, where the sample grayscale image represents sample data for vehicle diagnosis, and the sample classification result indicates a vehicle fault condition. In some embodiments of the disclosure, the sample data is data within a predetermined time period that ends at a time point at which occurrence of a fault is determined according to empirical rules, and the sample classification result is a vehicle fault condition determined according to the empirical rules. In this field, the vehicle fault condition determined according to empirical rules may also be used to label the sample data.

Then, in the training process, the convolutional neural network and the self-attention neural network are trained by using the sample grayscale image as an input of the convolutional neural network and the sample classification result as a target output of the self-attention neural network. After the training using the sample grayscale image and the sample classification result, the neural network architecture 40 finally will tend to converge, and each parameter obtained through the training may be solidified and copied for distribution on a neural network architecture based on similar hardware.

According to another aspect of the disclosure, there is provided a computer-readable storage medium having instructions stored therein, where the instructions, when executed by a processor, cause the processor to perform any one of the vehicle fault diagnosis methods as described above. The computer-readable medium in the disclosure includes various types of computer storage media, and may be any usable medium accessible to a general-purpose or special-purpose computer. For example, the computer-readable medium may include a RAM, a ROM, an EPROM, an EEPROM, a register, a hard disk, a removable hard disk, a CD-ROM or another optical memory, a magnetic disk memory or another magnetic storage device, or any other transitory or non-transitory media that can carry or store expected program code having an instruction or data structure form and be accessible to the general-purpose or special-purpose computer or a general-purpose or special-purpose processor. Data is usually copied magnetically in a disk used herein, while data is usually copied optically by using lasers in a disc. A combination thereof shall also fall within the scope of protection of the computer-readable media. An exemplary storage medium is coupled to a processor, so that the processor can read information from and write information to the storage medium. In an alternative solution, the storage medium may be integrated into the processor. The processor and the storage medium may reside in an ASIC. The ASIC may reside in a user terminal. In an alternative solution, the processor and the storage medium may reside as discrete assemblies in a user terminal.

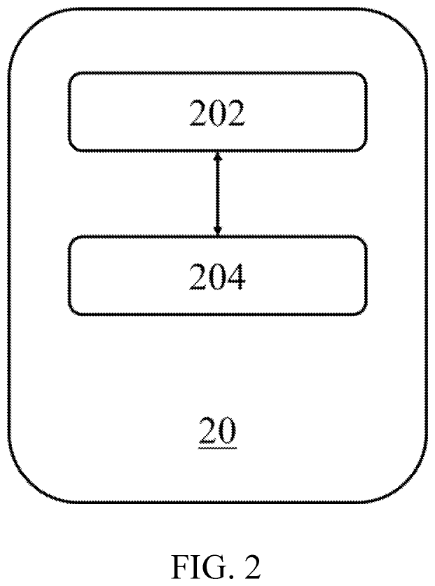

According to another aspect of the disclosure, there is provided a vehicle diagnosis device. As shown in FIG. 2, a vehicle diagnosis device 20 includes a memory 202 and a processor 204. As shown by the arrows in FIG. 2, the processor 204 may read data in the memory 202 and may also write data into the memory 202. The vehicle diagnosis device 20 may further include another software and hardware module, and for the sake of clearly describing the principles of the disclosure, descriptions of these modules are omitted herein. The memory 202 of the vehicle diagnosis device 20 is configured to store instructions, and the processor 204 is configured to execute these instructions to cause the processor 204 to perform any one of the vehicle fault diagnosis methods as described above.

The disclosure integrates the convolutional neural network (visual processing), attention neural network (semantic processing), and a solubility mechanism based on correlation propagation of hierarchical optimization, which implements classification prediction/attribution for multivariate time series signals. In addition, the contribution to the obtained prediction result is also visualized, providing convenience for big data mining in fields such as new energy vehicles. This can be applied to new energy vehicle after-sales problem localization, warning systems, etc. The foregoing descriptions are merely the embodiments of the disclosure, but are not intended to limit the scope of protection of the disclosure. Any feasible variation or replacement conceived by a person skilled in the art within the technical scope disclosed in the disclosure shall fall within the scope of protection of the disclosure. Without conflicts, the embodiments of the disclosure and features in the embodiments may also be combined with each other. The scope of protection of the disclosure shall be subject to recitations of the claims.

What is claimed is:

1. A vehicle fault diagnosis method, comprising:
receiving a grayscale image, wherein the grayscale image represents diagnostic data for vehicle diagnosis;
extracting features from the grayscale image by using a convolutional neural network, to generate a feature map;
performing self-attention-based processing on the feature map to obtain a classification result, wherein the classification result indicates a vehicle fault condition; and
performing a relevance propagation analysis based on the classification result to obtain a contribution heat map, wherein the contribution heat map indicates a degree of contribution of each pixel in the grayscale image to the classification result.

2. The method according to claim 1, wherein the self-attention-based processing comprises:
inputting the feature map into a multi-head attention layer of a self-attention neural network to extract a feature matrix;
inputting the feature matrix into a dense layer of the self-attention neural network to generate a sparse matrix; and
inputting the sparse matrix into a fully connected and softmax layer of the self-attention neural network to obtain the classification result.

3. The method according to claim 1, wherein the grayscale image is generated by the following steps:
extracting the diagnostic data, wherein the diagnostic data comprises data generated by at least one source in a vehicle at a plurality of time points;
selecting valid data within a predetermined time period from the diagnostic data by filtering;
normalizing each value in the valid data;
mapping each normalized value in the valid data to a gray level of the grayscale image; and
constructing the grayscale image based on the corresponding gray level of each normalized value in the valid data, wherein the grayscale image has a first dimension corresponding to the source and a second dimension corresponding to the time point.

4. The method according to claim 3, wherein generating the grayscale image further comprises the following steps:
supplementing a normalized value for each source during a power-off time period after the normalization; and
performing filtering on each normalized value in the valid data.

5. The method according to claim 2, further comprising:
receiving a sample grayscale image and a sample classification result corresponding thereto, wherein the sample grayscale image represents sample data for vehicle diagnosis, and the sample classification result indicates a vehicle fault condition; and
training the convolutional neural network and the self-attention neural network by using the sample grayscale image as an input of the convolutional neural network and the sample classification result as a target output of the self-attention neural network.

6. The method according to claim 5, wherein the sample data is data within a predetermined time period that ends at a time point at which occurrence of a fault is determined according to empirical rules, and the sample classification result is a vehicle fault condition determined according to the empirical rules.

7. The method according to claim 2, wherein the performing a relevance propagation analysis based on the classification result to obtain a contribution heat map comprises:
performing the relevance propagation analysis based on the classification result by using a relevance analysis neural network, wherein
the relevance analysis neural network comprises corresponding layers respectively coupled with all layers in the convolutional neural network and with all the layers in the self-attention neural network.

8. The method according to claim 1, wherein the diagnostic data is generated based on sensor data of a vehicle.

9. A computer-readable storage medium having instructions stored therein, wherein the instructions, when executed by a processor, cause the processor to perform a vehicle fault diagnosis method, which comprising:
receiving a grayscale image, wherein the grayscale image represents diagnostic data for vehicle diagnosis;
extracting features from the grayscale image by using a convolutional neural network, to generate a feature map;
performing self-attention-based processing on the feature map to obtain a classification result, wherein the classification result indicates a vehicle fault condition; and
performing a relevance propagation analysis based on the classification result to obtain a contribution heat map, wherein the contribution heat map indicates a degree of contribution of each pixel in the grayscale image to the classification result.

10. The computer-readable storage medium according to claim 9, wherein the self-attention-based processing comprises:
inputting the feature map into a multi-head attention layer of a self-attention neural network to extract a feature matrix;
inputting the feature matrix into a dense layer of the self-attention neural network to generate a sparse matrix; and
inputting the sparse matrix into a fully connected and softmax layer of the self-attention neural network to obtain the classification result.

11. The computer-readable storage medium according to claim 9, wherein the grayscale image is generated by the following steps:
extracting the diagnostic data, wherein the diagnostic data comprises data generated by at least one source in a vehicle at a plurality of time points;
selecting valid data within a predetermined time period from the diagnostic data by filtering;
normalizing each value in the valid data;
mapping each normalized value in the valid data to a gray level of the grayscale image; and
constructing the grayscale image based on the corresponding gray level of each normalized value in the valid data, wherein the grayscale image has a first dimension corresponding to the source and a second dimension corresponding to the time point.

12. The computer-readable storage medium according to claim 11, wherein generating the grayscale image further comprises the following steps:
supplementing a normalized value for each source during a power-off time period after the normalization; and
performing filtering on each normalized value in the valid data.

13. A vehicle diagnosis device, comprising:
a memory configured to store instructions; and
a processor configured to execute the instructions to cause a vehicle fault diagnosis method to be performed, which comprising:
receiving a grayscale image, wherein the grayscale image represents diagnostic data for vehicle diagnosis;
extracting features from the grayscale image by using a convolutional neural network, to generate a feature map;
performing self-attention-based processing on the feature map to obtain a classification result, wherein the classification result indicates a vehicle fault condition; and
performing a relevance propagation analysis based on the classification result to obtain a contribution heat map, wherein the contribution heat map indicates a degree of contribution of each pixel in the grayscale image to the classification result.

14. The device according to claim 13, wherein the self-attention-based processing comprises:
inputting the feature map into a multi-head attention layer of a self-attention neural network to extract a feature matrix;
inputting the feature matrix into a dense layer of the self-attention neural network to generate a sparse matrix; and
inputting the sparse matrix into a fully connected and softmax layer of the self-attention neural network to obtain the classification result.

15. The device according to claim 13, wherein the grayscale image is generated by the following steps:
extracting the diagnostic data, wherein the diagnostic data comprises data generated by at least one source in a vehicle at a plurality of time points;
selecting valid data within a predetermined time period from the diagnostic data by filtering;
normalizing each value in the valid data;
mapping each normalized value in the valid data to a gray level of the grayscale image; and
constructing the grayscale image based on the corresponding gray level of each normalized value in the valid data, wherein the grayscale image has a first dimension corresponding to the source and a second dimension corresponding to the time point.

16. The device according to claim 15, wherein generating the grayscale image further comprises the following steps:
supplementing a normalized value for each source during a power-off time period after the normalization; and
performing filtering on each normalized value in the valid data.

17. The device according to claim 14, wherein the vehicle fault diagnosis method further comprises:
receiving a sample grayscale image and a sample classification result corresponding thereto, wherein the sample grayscale image represents sample data for vehicle diagnosis, and the sample classification result indicates a vehicle fault condition; and
training the convolutional neural network and the self-attention neural network by using the sample grayscale image as an input of the convolutional neural network and the sample classification result as a target output of the self-attention neural network.

18. The device according to claim 17, wherein the sample data is data within a predetermined time period that ends at a time point at which occurrence of a fault is determined according to empirical rules, and the sample classification result is a vehicle fault condition determined according to the empirical rules.

19. The device according to claim 14, wherein the performing a relevance propagation analysis based on the classification result to obtain a contribution heat map comprises:
performing the relevance propagation analysis based on the classification result by using a relevance analysis neural network, wherein
the relevance analysis neural network comprises corresponding layers respectively coupled with all layers in the convolutional neural network and with all the layers in the self-attention neural network.

20. The device according to claim 13, wherein the diagnostic data is generated based on sensor data of a vehicle.
